(19) United States
(12) Patent Application Publication
(10) Pub. No.: US 2005/0221017 A1
(43) Pub. Date: Oct. 6, 2005

(54) Method of heat treating coatings by using microwave

(76) Inventors: Vladislav Sklyarevich, Bensalem, PA (US); Mykhaylo Shevelev, Feasterville, PA (US)

Correspondence Address: CAROTHERS AND CAROTHERS;Suite 500, 445 Fort Pitt Blvd., Pittsburgh, PA, 15219, US

(21) Appl. No.: 10/814,057

(22) Filed: Mar. 30, 2004

(51) Int. Cl. B05D 5/12; B05D 3/00

(52) U.S. Cl. 427/457; 427/532

(57) ABSTRACT

A method for heat treatment of coatings for application to metal surfaces wherein a ceramic is positioned adjacent to the coating to be treated and the ceramic is exposed to a microwave beam having a predetermined frequency and power density which are sufficient to heat the ceramic to a desired temperature whereby the coating is adhered to an applied metal surface without temperature degradation of the metal.

### FIELD OF INVENTION

This invention relates to a high temperature rapid thermal treatment with the use of microwave for the application of any type of thin non-metal coating mainly on metallic surfaces, such as the sintering of polymer coatings on blade edges, by ultra rapidly and exclusively heating the coatings so that the coatings can be processed without significant heating of metal parts to avoid their degradation and/or oxidation. Items that may be thermally treated by the inventive method include shaving and surgical blades, knifes, machine parts with protective coatings, and the like.

The present invention relates to processing coatings also applied to non-metal substrates, as well as for performing the operations of melting, baking, and heat treating the surfaces of metals and non-metallic materials, for example for the production of wire wrapping films and the like.

### BACKGROUND OF THE INVENTION

There are an extensive number of metal items in which the work surfaces are coated by thin non-metallic coatings such a ceramics, polymers, and the like. However, said coatings in most cases require additional heat treatment for curing, sintering, melting, baking, mineralization, drying, etc. that is conducted in conventional ovens. Despite the fact that said coatings are usually less than 1% (more often less then 0.1%) of total coated item weight there is the need to heat the entire item. As a result, long processing time, low energy efficiency and reduced item quality occur. Additionally, heating of metal parts leads very often to metal oxidation and degradation.

Energy consumption and time of processing can be significantly reduced and quality increased if it is possible to heat only the coating. However, such exclusive heating is a very difficult task because of the ultra-thin character of the coatings and, more significantly, because of the high thermal conductivity of the metal surfaces to which coatings are applied.

It is clear that to overcome the speed of metal thermal conductivity, heating of the coating should be ultra rapid. This means that the heat flux should also be intensely powerful to process the coating and meet the desired processing speed. Achieving such a high heat flux might be possible by using two heat transfer modes: conductive and radiant. Conductive heat transfer depends on the temperature of the heater and the distance between the heater and the object being heated. Radiant heat transfer depends on the heater temperature (proportional to T⁴). Therefore, it is clear that the selected heater should have a working temperature as high as possible (for radiant heat) and should also have the capability to be placed in close proximity to the object, or as close as possible, to achieve the desired heat conduction.

There are a limited number of heat sources that can be considered as a suitable candidate for this. The first and least expensive type is infrared. The power of an infrared heater is mostly dependant on temperature and therefore powerful, high temperature IR heaters have working temperatures of around 1200-1600 C. Heaters with such temperatures can work only in a vacuum because their heating elements (mostly tungsten and carbon) need to be protected from oxidation. Heaters with built-in protection (balloons, shield metal, etc.) can work in air but this protection significantly reduces heat transfer. Besides it is difficult if not impossible to bring IR heater close to the heated object because this creates serious heat uniformity problems.

Laser is not a good candidate because it has only radiant heat and there are no lasers that can provide the necessary heat flux. Use of an electron beam source requires enclosing the processing items in a vacuum, making the resulting processing speed unacceptable and expensive.

More promising is using indirect microwave where the heat is generated by ceramics that in turn are heated by microwave. In such an approach, the ceramic part can be located close enough to the processed surface and both conductive and radiant heat can be utilized. There are a few US patents (U.S. Pat. Nos. 3,778,578; 4,417,116; 5,265,444; 5,420,401; 5,512,734, and others) that describe different configurations of heat exchangers. All of them use non-concentrated microwaves and therefore their efficiency is low. Besides it is very difficult to achieve uniform microwave power distribution near the ceramic part, leading to non-uniformity of the ceramic temperature and reduced quality of the processed coatings. In many cases this makes processing useless. Moreover any changes in the proximity to the ceramic, such as motion of the metal items, changing their sizes, etc. results in dramatic amplification of said non-uniformity. This makes it completely impossible to use these exchangers for actual production. Besides, all these inventions allow the achievement of temperatures which are no more than 1600 C. This temperature level is not high enough if it is necessary to process coatings without significantly heating metal parts. This is illustrated by the following example and FIG. 1.

Coating (1) (see FIG. 1) is heated by radiant and conduction fluxes of energy from hot ceramic (2) that is irradiated by microwave (3). Part of this heat is transferred continuously inside the metal part (4) by thermal conductivity. As a result the particular temperature distribution T(x) across the coating-metal interface will be created that can be described by the following heat equation (1).
∂T/∂t=λ/(cρ)∂²T/∂x², (1)
(where λ is the heat transfer coefficient; c is specific heat; ρ is material density)

From this heat equation, it is possible to estimate the temperature distribution (from coating to within the metal) vs ceramic temperature.

In the illustrated calculations the following conditions are selected:
λ(W/(m ° C.) of: air=3E-2 coating=0.3 metal=40
c(J/(g ° C.) of: air=1.1E4 coating=1E3 metal=5E2
ρ(kg/m³) of: air=1 coating=1.5E3 metal=8.1E3
Starting metal temperature (T₀)=100 C
D_{T}=5E-6 m=5 micron
D_{M}=12 mm
Boundary conditions
   a) Heat stream from the blade bottom are:
      Q=K(T_{M1}−T_{E}),
      where K is the coefficient and K=60 W/(m²C); T_{M1}=temperature on the blade bottom; T_{E}=embodiment temperature.
   b) Heat flow into the coatings are:
      Q=K(Tₐ−T_{T})+ησT⁴ₛ
      where Tₐ is the air temperature on coating surface; Tₛ is the temperature on the heated ceramic surface; T_{T} is the coating temperature; η is the ceramic emissivity and is equal 0.6; σ is the Stefan-Boltzmann constant, σ=5.67E-8 W/(m^{2o}K⁴).

The results of these calculations are shown in FIG. 2. The data presented in FIG. 2 illustrates that if, for example, the processing coating temperature is around 370-400 C (polymer coatings on metal blades case), maintaining of the metal temperature lower than 350 C (to avoid blade metal degradation) requires heating of the ceramic by microwave to a temperature higher than 1600-1700 C. For treatment of coatings with a higher processing temperature, the ceramic for the heat exchanger should be heated much higher.

None of the existing heat exchangers (ovens) using microwave energy can generate heat with such a high temperature.

Using any type of microwave for direct heating thin coatings as is described in United States Patent Application Publication No. 2003/0224115, Raymond Guimont, Dec. 4, 2003, also cannot provide application of thin coatings on to a metal surface without significant heating of the metal. Polymer films with thickness of about 5-10 microns that are applied on metal surfaces, in fact, cannot be heated by microwave directly because they are too thin compared to the microwave wavelength and because the metal substrate works as a screen and reflects the microwave radiation. Metal itself can be heated in this case and film can be cured only from this heat. However the efficiency of this process will be only a fraction of a percent. For example, stainless that has an electrical resistivity of around 10⁻⁷ Ohms (see, for example Handbook of Chemistry and Physics, 80^{th} edition 1999-2000, David R. Lide, editor, CRC Press) will reflect more than 99% of incident microwave power and absorb significantly less then 1% (see, for example, Principles of Optics, second revised edition, Born and Wolf, Macmillan, 1964). Such a low level of absorption does not allow the provision of fast and exclusive heating of the coating. An evaluation of the heat equation (1) for this process shows that even for high microwave power density, for example, 10,000 kW per sq inch, the temperature that is needed for curing the coating (300 C-400 C) requires such a long irradiation that it allows heat to penetrate inside of the metal. The energy efficiency and productivity of this process is considerably less than that of existing conventional ovens.

### SUMMARY OF THE INVENTION

According to the present invention, a method of processing coatings by using microwave is provided for the thermal treatment of any non-metallic coating without significantly heating the metal part of item being coated. The products prepared using these treatments include, but are not limited to, shaving and surgical blades, various machine parts with protective coatings, knifes, and the like. This method also can be used for coatings on non-metal substrates, for heat treatment of metals, and annealed materials.

The present invention provides a method for heat treatment of coatings by positioning a ceramic adjacent to the coating to be treated. The ceramic is exposed to a microwave beam having a predetermined frequency and power density which are sufficient to heat at least a selected area of the ceramic to a desired temperature whereby the coating is adhered to an applied metal surface without temperature degradation of the metal. In a preferred embodiment the microwave beam is delivered to the ceramic in a quasi optical manner through the use of a metal mirror to provide the necessary temperature distribution within the ceramic.

The main advantage of this innovation is achievement of highest quality of processed coatings without degradation of metal parts. Many other specific advantages also exist including, but not limited to, the feasibility of incorporation into production lines for mass production with low manufacturing and capital costs.

### BRIEF DESCRIPTION OF THE DRAWINGS

Other objects and advantages appear hereinafter in the following description and claims. The accompanying drawings show, for the purpose of exemplification, without limiting the scope of the invention or appended claims, certain practical embodiments of the present invention wherein:

FIG. 1 schematically illustrates prior art methods of heating coatings;

FIG. 2 graphically illustrates the temperature profile that is obtained in the metal substrate when it is heated under prior art conditions by conductive and radiant heat from hot ceramic;

FIG. 3 schematically illustrates the method of the present invention;

FIG. 4 diagrammatically illustrates the interaction process of the microwave beam with ceramic;

FIGS. 5a, 5b, and 5c graphically and diagrammatically illustrate the interaction process of the microwave beam with ceramics of different thicknesses;

FIG. 6 graphically illustrates the interaction process of the microwave beam with ceramic when ceramic thickness is equal to the size of the skin layer for the frequency of the microwave beam used;

FIG. 7 schematically illustrates the method of the present invention wherein a gyrotron beam is directed to the work surface of the ceramic; and

FIG. 8 schematically illustrates the method of the present invention wherein ceramic powder is used.

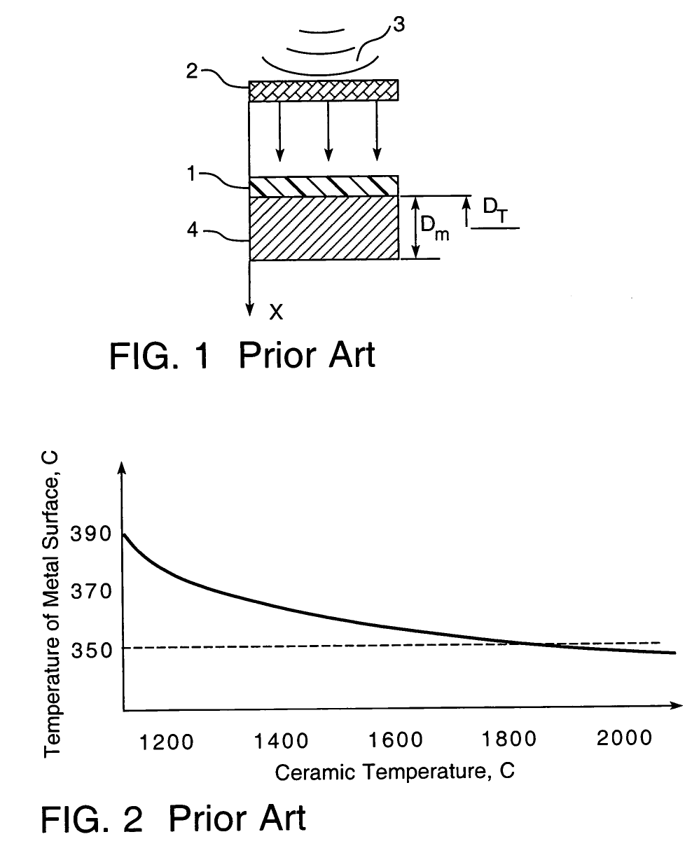

### DETAILED DESCRIPTION OF PREFERRED EMBODIMENTS

This invention relates to a high-temperature rapid thermal treatment, with the assistance of microwave, of any type of thin non-metal coating, mainly on metallic item surfaces, preferably sintering of polymer coatings without significant heating of the metal parts to avoid degradation and/or oxidation. Items that may be thermally treated by the inventive method include shaving and surgical blades, knifes, machine parts with protective coatings, and the like. This method can be also used for sintering coatings on non-metallic substrates, and for heat treatment of metal and non-metal surfaces as well.

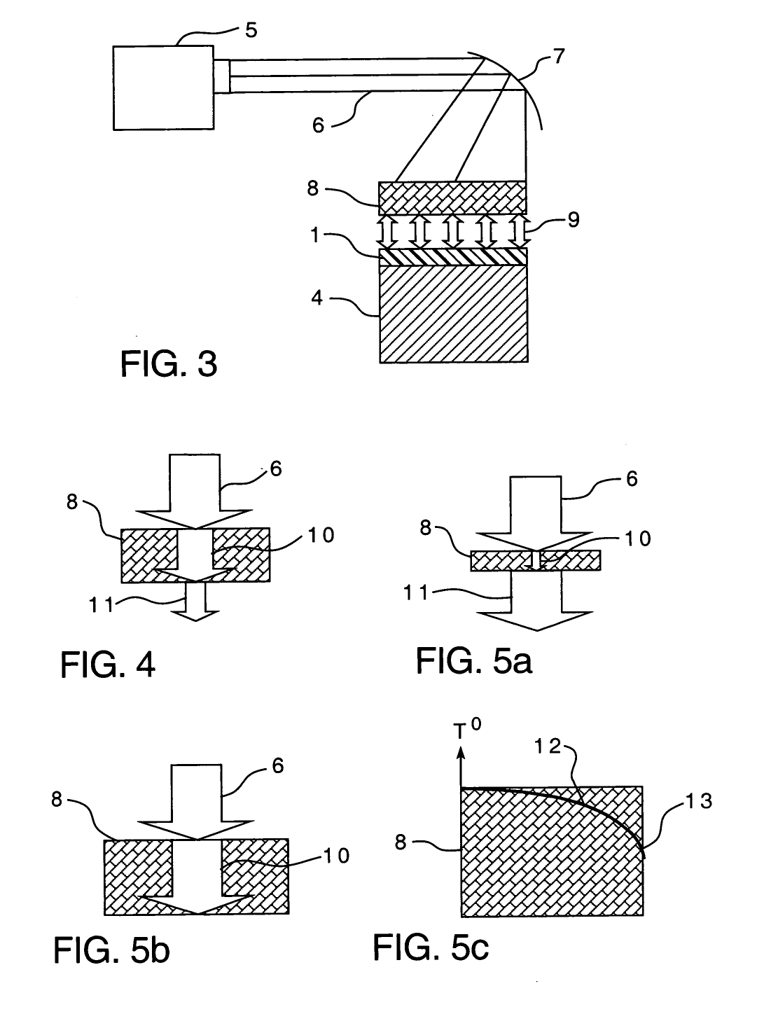

In the invention, ceramic 8 (see FIG. 3) is placed close to coating 1 and is heated by microwave beam 6. Conduction and radiant heat fluxes 9 emanate from the ceramic heat the coating layer 1 of the metallic item 4.

The microwave beam is generated by a special generator 5 which is a gyrotron that is able to emit concentrated high frequency and high power density microwave radiation. The beam 6 is directed to the ceramic 8 in a quasi-optical manner, for example, by a metal mirror 7. Additionally, the mirror 7 can reconfigure the microwave beam 6 so that it matches the size and configuration of the ceramic and can create the necessary uniformity of distribution by appropriate design shape of the mirror surface. The shape and uniformity of the beam (heat spot) can be achieved by the controllable scanning of the mirror 7.

In the present invention a microwave beam with appropriate frequency and power density is used for transferring microwave energy into conduction and radiant heat. In all of the embodiments of the invention the wavelength (frequency) of the microwave, the power density of the applied microwave beam, and the kind and thickness of the ceramic, are all important parameters of the invention that must be considered. These parameters are chosen so as to heat the ceramic with the highest efficiency. These parameters and how they are chosen are generally described below.

The particular frequency chosen should be cost effective and microwave generators for the selected frequency should be readily available at the required power. In actuality, there are not many choices available. The gyrotron is the only comparatively inexpensive microwave generator that produces high power, concentrated microwave energy of up to 200 kW, in a frequency range between 24 GHz and 200 GHz.

The main requirement for the ceramic material includes a high melting point (higher than 2000 C) and the ability to resist oxidation under these temperatures. The following kinds of ceramic meet this temperature level: Al2O3, Ti2O3, Cr2O3, Y2O3, CrO2, La2O2, HfO2, MgO, and some others. When microwave radiation 6 is applied to a ceramic 8 (see FIG. 4), part of the microwave radiation 10 passes through the ceramic 8 and heats it and part of it as indicated at 11 does not.

The ratio of incident microwave power 6 and the absorbed part 10 determines the efficiency of the heat process. For some particular frequencies it depends on the electromagnetic properties (first of all absorption) and the thickness of the ceramic material. Because all high temperature oxide ceramics have approximately the same electromagnetic properties, high efficiency can be achieved primarily by selecting a wide thickness of irradiated ceramic. There are three cases here that apply. If the width of the ceramic is too thin, the microwave energy 11 would be too great, much greater than what is used to heat the ceramic part 10 (see FIG. 5a). For a thick ceramic 8 (see FIG. 5b) 100% of the incident microwave power 6 is absorbed. However, using too thick a ceramic leads to the creation of a sharp temperature distribution 12 inside the ceramic 8 and temperatures on the ceramic work surface 13 will be too low.

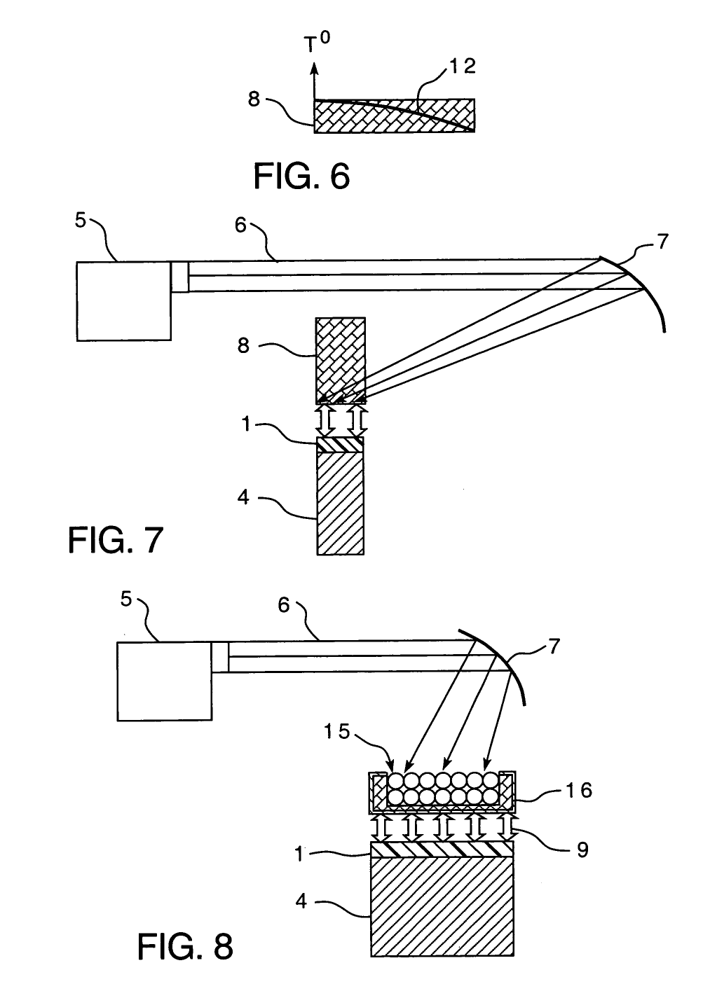

The optimal ceramic thickness can be considered as equal to the size of the skin layer for the used frequency of the microwave beam. In this case most of the energy will be utilized inside the ceramic and a temperature distribution 12 (see FIG. 6) inside the ceramic 8 of adequate uniformity can be achieved.

For most high temperature oxide ceramic materials, the skin layer for a frequency of 10 GHz-200 GHz and a temperature of around 1900-2000 C ranges from approximately 1 to 5 mm.

The temperature of the work surface 14 of the ceramic 8 (see FIG. 7) can be increased if this surface is irradiated directly by the microwave beam. In this case, the total ceramic thickness is not critical.

The lifespan of the ceramic can be further increased when high temperature oxide ceramic powder 15 (see FIG. 8) is used. The powder can be placed in a thick form as indicated at 16, which is made from a material with a higher melting point and lower absorption than the powder. Configuration of the form can be varied. The thickness of powder layer should also be maintained around the skin layer of the powder material.

The method of the present invention is generally applicable to the thermal treatment of any type of coatings that include, but are not limited to, polymers, ceramics, and metal.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

1. A method for heat treatment of coatings comprising:
positioning a ceramic adjacent to a coating to be treated;
exposing said ceramic to a microwave beam having a predetermined frequency and power density which are sufficient to heat at least a selected area of the ceramic to a desired temperature whereby said coating will be adhered to an applied metal surface without temperature degradation of the metal.

2. The method of claim 1 wherein the microwave beam is a gyrotron beam.

3. The method of claim 1 wherein the ceramic is selected from a group consisting of oxide ceramic materials in a solid state or a powder based on silicon dioxide, and oxides of aluminum, zirconium, or magnesium having a melting point higher than 2000 C.

4. The method of claim 1 wherein the microwave beam frequency is between about 10 GHz to about 200 GHz.

5. The method of claim 1 wherein the microwave beam is delivered to said ceramic in a quasi optical manner.

6. The method of claim 5 wherein the microwave beam is delivered to said ceramic by a metal mirror.

7. The method of claim 6 wherein the necessary configuration of the microwave beam and uniformity of power within the microwave beam is formed by said metal mirror.

8. The method of claim 6 wherein the necessary temperature distribution within said ceramic is formed by a scanning microwave beam via the mirror.

9. The method of claim 1 wherein a top surface of the ceramic which is farthest from the said coating is exposed to the microwave beam.

10. The method of claim 1 wherein the thickness of said ceramic is approximately equal to the skin layer for the selected microwave beam frequency.

11. The method of claim 1 wherein the thickness of said ceramic is preferably selected to be in the range of 1 to 5 mm.

12. The method of claim 1 wherein a bottom surface of the ceramic which is facing said coating is exposed to the microwave beam.
